(19) United States
(12) Patent Application Publication
(10) Pub. No.: US 2010/0019730 A1
(43) Pub. Date: Jan. 28, 2010

(54) Tamper Detection And Disabling System For A Battery

(75) Inventors: Yung Fa Chueh, Hsichin City (TW); Wen-Yung Chang, Chungli City (TW); Chia Fa Chang, Linkou Township (TW); Tun Chieh Liang, Taipei (TW)

Correspondence Address: HAYNES AND BOONE, LLP;IP Section, 2323 Victory Avenue, Suite 700, Dallas, TX, 75219, US

(73) Assignee: Dell Products L.P., Round Rock, TX (US)

(21) Appl. No.: 12/178,760

(22) Filed: Jul. 24, 2008

(51) Int. Cl. H02J 7/00

(52) U.S. Cl. 320/135

(57) ABSTRACT

A battery includes a battery chassis defining a housing. A tamper detection system is located in the housing and is operable to detect an access of the housing. A disabling system is located in the housing, coupled to the tamper detection system, and operable to disable a power supply function in response to the tamper detection system detecting the access of the housing.

### BACKGROUND

The present disclosure relates generally to information handling systems, and more particularly to a tamper detection and disabling system for a battery in an information handling system.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Many IHSs include battery packs to, for example, increase the mobility of the IHS. These battery packs are typically subject to qualification testing to ensure that they will function properly with the IHS. Because the battery cells in the battery packs have a finite lifespan, the battery cells and/or the battery packs must eventually be replaced if continued mobility of the IHS is desired. The replacement of battery cells and/or battery packs for an IHS can raise a number of issues.

For example, there are many third parties that offer IHS users a service that will ‘refurbish’ the battery for an IHS by replacing the expired battery cells in the battery pack or IHS. These third parties will typically open up the sealed battery pack or IHS in order to remove the expired battery cells and replace them with new battery cells. However, these new battery cells typically have not been qualification tested to ensure that they will function properly with the IHS, which can lead to problems with the IHS function and damage to the IHS manufacturers reputation, as the battery pack or IHS will typically be branded with the manufacturers name but the battery cells within them may not be up the manufacturers quality standards.

Accordingly, it would be desirable to provide a tamper detection and disabling system for a battery in order to remedy the issues discussed above.

### SUMMARY

According to one embodiment, a battery includes a battery chassis defining a housing, a tamper detection system located in the housing and operable to detect an access of the housing, and a disabling system located in the housing, coupled to the tamper detection system, and operable to disable a power supply function in response to the tamper detection system detecting the access of the housing.

### BRIEF DESCRIPTION OF THE DRAWINGS

FIG. 1 is a schematic view illustrating an embodiment of an IHS.

FIG. 2a is a perspective view illustrating an embodiment of a chassis for housing a battery.

FIG. 2b is a schematic view illustrating an embodiment of the chassis of FIG. 2a.

FIG. 2c is a schematic view illustrating an embodiment of a battery control system used in the chassis of FIG. 2b.

FIG. 2d is a schematic view illustrating an embodiment of a circuit used in the battery control system of FIG. 2c.

FIG. 3a is a flow chart illustrating an embodiment of a method for limiting tampering with a battery.

FIG. 3b is a perspective view illustrating an embodiment of the housing in the chassis of FIG. 2a being accessed.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

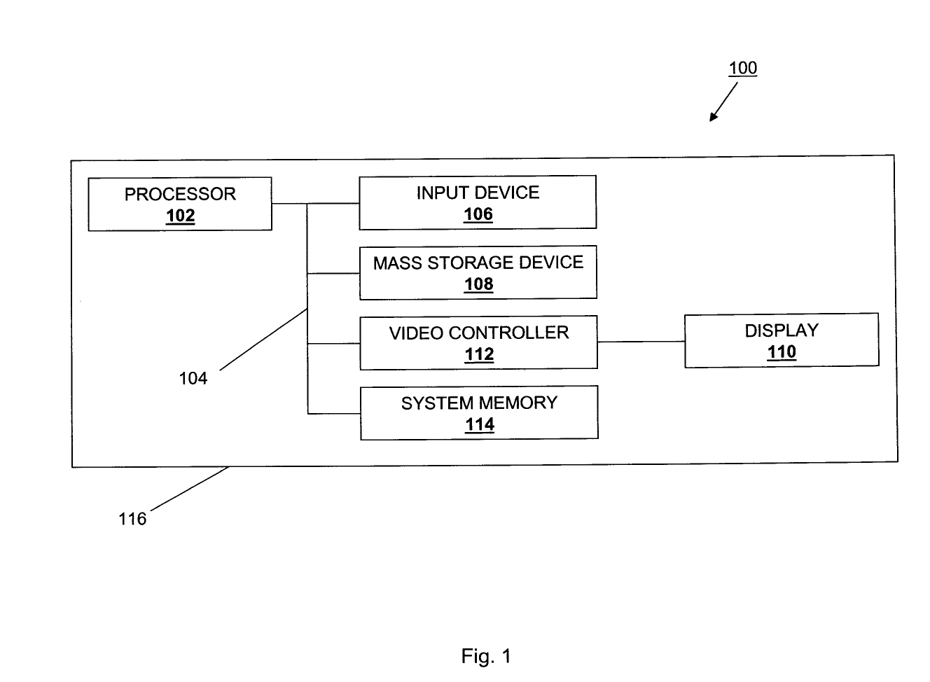

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

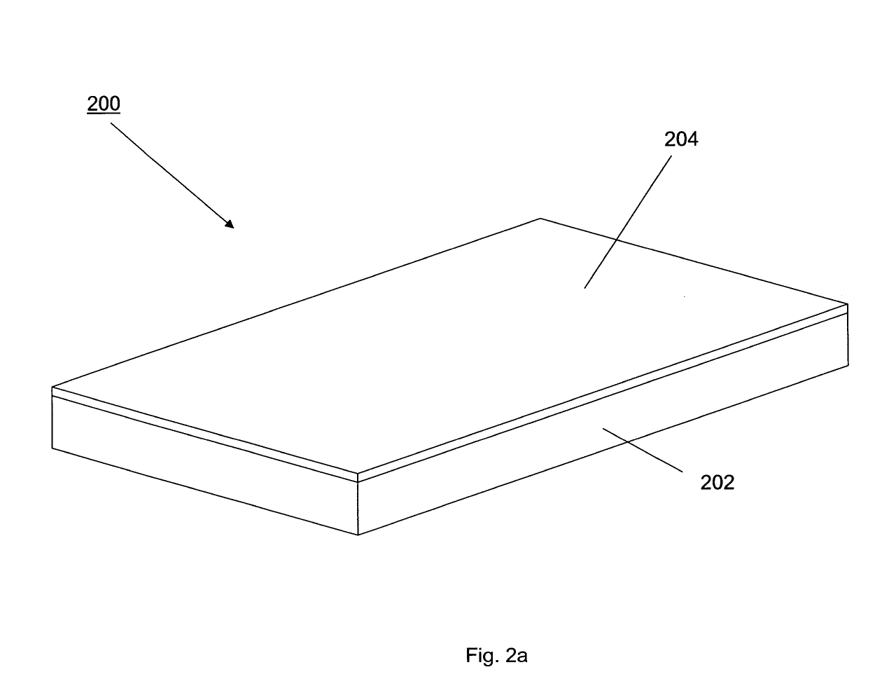

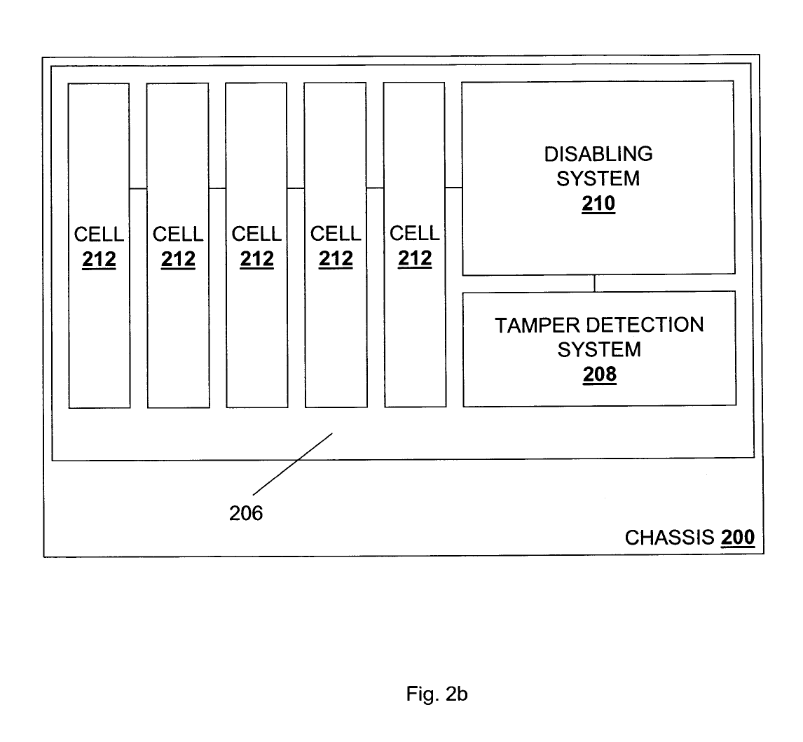

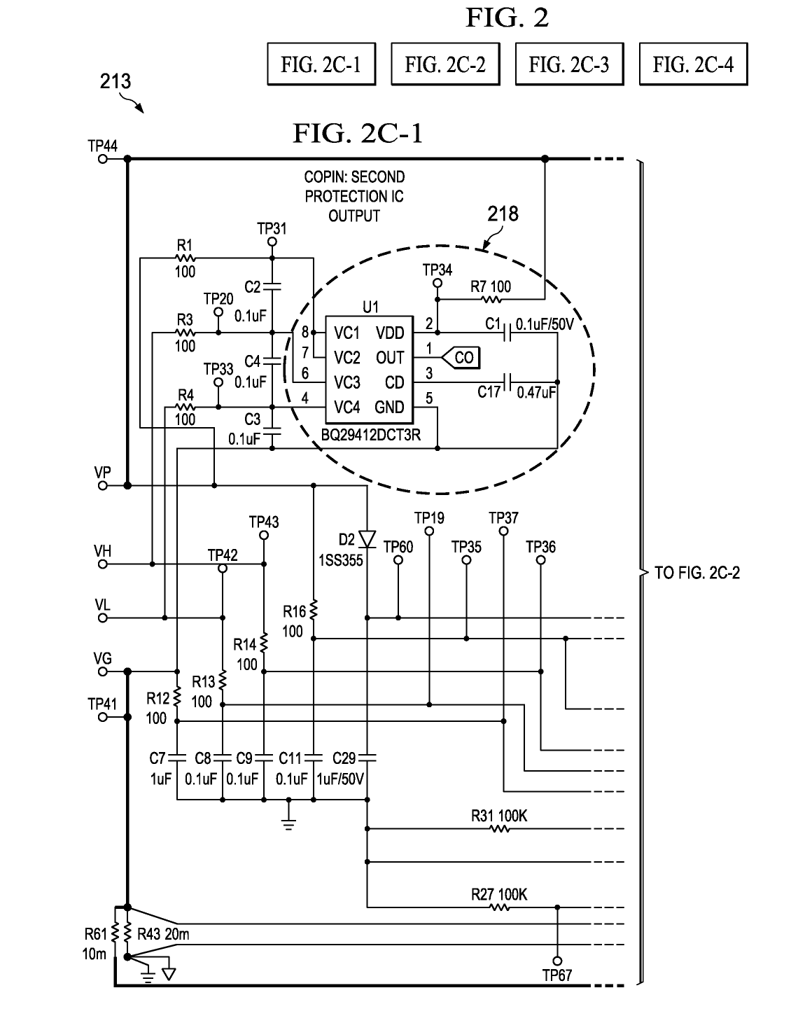

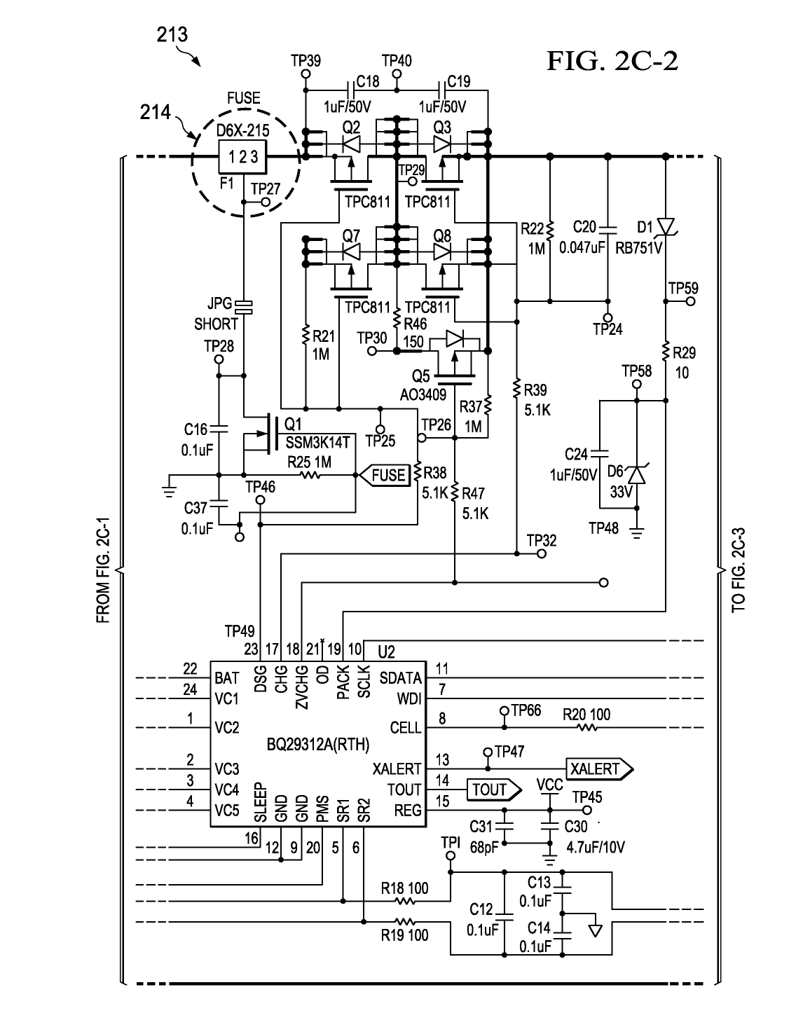

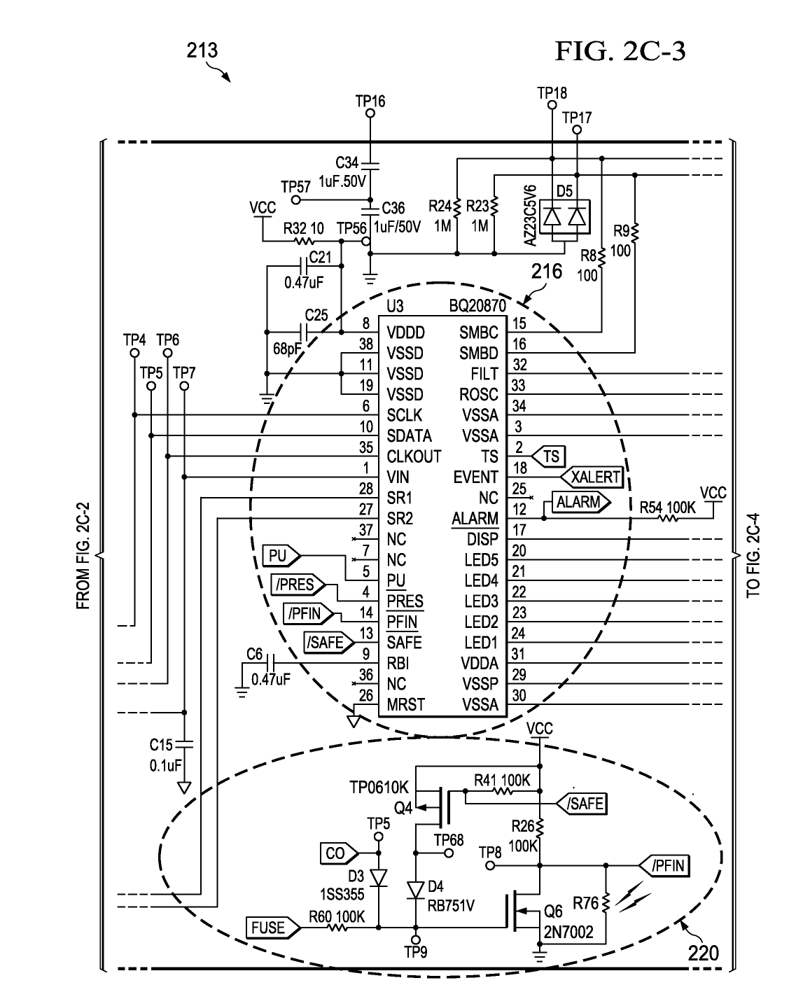

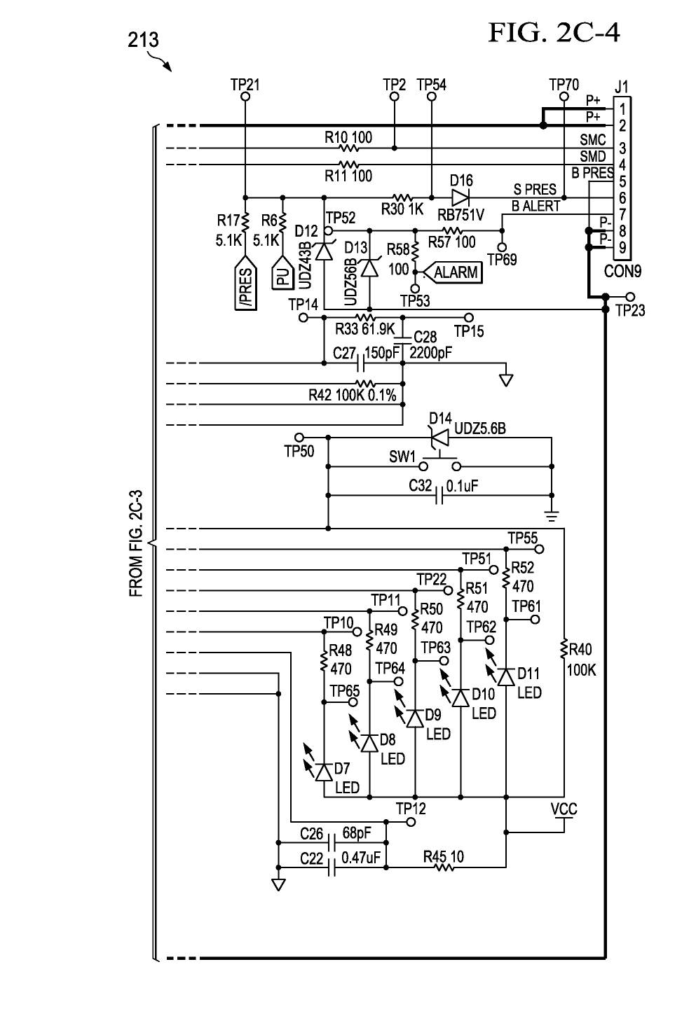

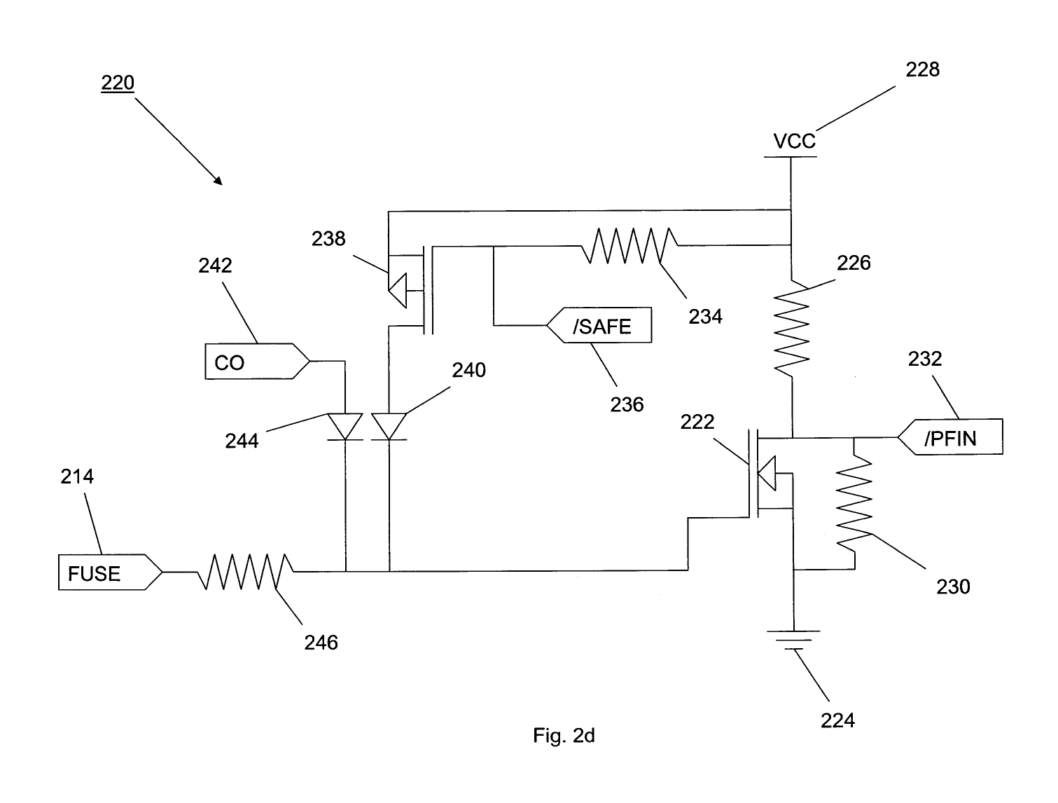

Referring now to FIGS. 2a and 2b, a chassis 200 is illustrated. In an embodiment, the chassis 200 may be a battery pack chassis that is operable to supply power to any device having the proper connections and housing for the battery pack chassis. In an embodiment, the chassis 200 may be the chassis 116, described above with reference to FIG. 1, with the provision that the chassis 200 includes battery components, discussed in further detail below, in addition to the IHS 100 components described above. The chassis 200 includes a base 202 and a cover 204 which is coupled to the base 202 and may be sealed to the base 202, as described in further detail below. A housing 206 is defined by the chassis 200 between the base 202 and the cover 204. A tamper detection system 208 is located in the housing 206. A disabling system 210 is located in the housing and coupled to the tamper detection system 208. A plurality of battery cells 212 are coupled to each other, the disabling system 210, and the tamper detection system 208. While the tamper detection system 208 and the disabling system 210 have been illustrated and described as located in the housing 206 of the chassis 200, one of skill in the art will recognize that some or all of the tamper detection system 208 and the disabling system 210 may be positioned in the chassis 200 in locations other than the housing 206.

Referring now to FIGS. 2c and 2d, an embodiment of the tamper detection system 208 and the disabling system 210 is illustrated in more detail. FIG. 2c illustrates a view of an embodiment of a battery control system 213 that includes both the tamper detection system 208 and the disabling system 210. In the illustrated embodiment, the battery control system 212 includes a fuse 214, a battery management unit (BMU) 216, and a protection circuit 218, all of which may be a portion of the disabling system 210. The battery control system 213 also includes circuit 220 that includes components of both the tamper detection system 208 and the disabling system 210, as described in further detail below. FIG. 2d illustrates an embodiment of the circuit 220 in more detail. In the illustrated embodiment, the circuit 220 includes a gate 222 that is coupled between a ground 224 and a resistor 226. A photoresistor 230 is coupled in parallel with the gate 222 and is also coupled to a PFIN 232 of the BMU 216, illustrated in FIG. 2c. In an embodiment, the photoresistor 230 is operable to reduce its impedance in response to being exposed to a light. The resistor 226 is coupled to a resistor 234 and a VCC power 228. The resistor 234 is coupled to a SAFE pin 236 of the BMU 216. A gate 238 is coupled to the SAFE pin 236 and, the VCC power 228, and a diode 240. A CO pin 242 of the protection circuit 218, illustrated in FIG. 2c, is coupled to a diode 244. Each of the diodes 240 and 244 are coupled to the gate 222 and a resistor 246. The fuse 214 is coupled to the resistor 246. While the circuit 220 has been described as illustrated in FIG. 2d, one of skill in the art will recognize that many changes (e.g., in circuit connections, circuit components, etc.) may be made without departing from the scope of the present disclosure.

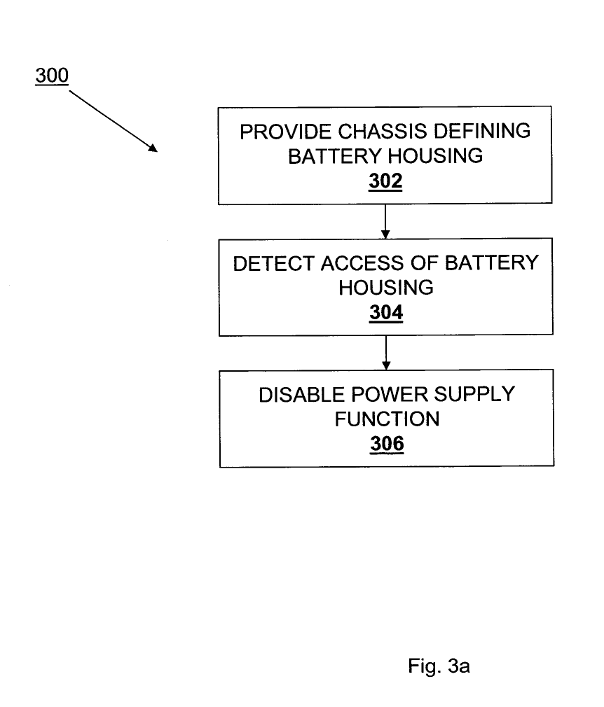

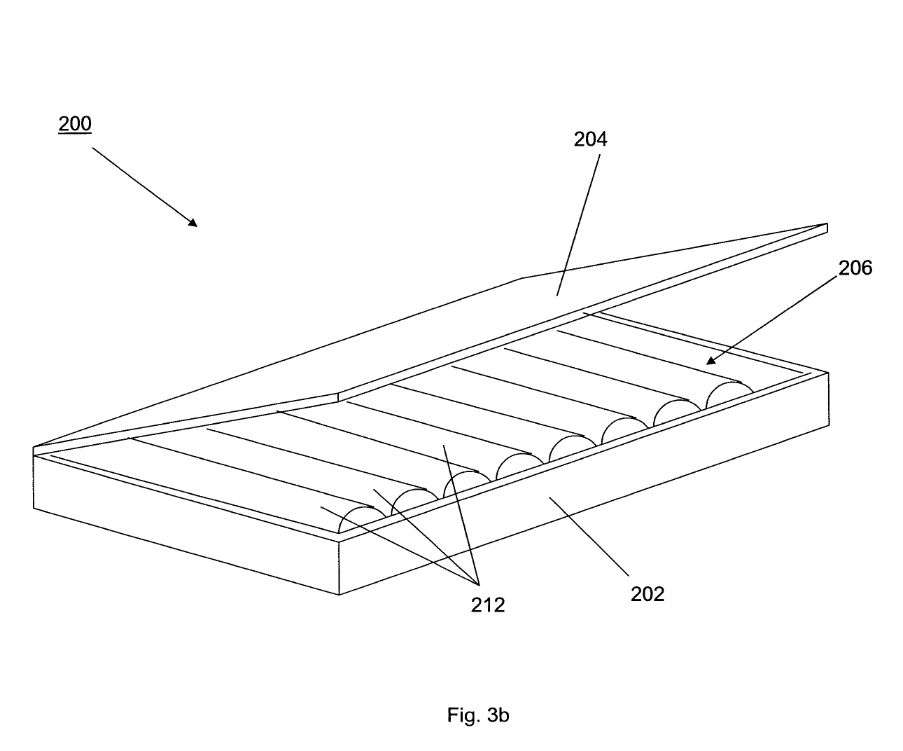

Referring now to FIGS. 2a, 2b, 2c, 2d, 3a and 3b, a method 300 for limiting tampering with a battery is illustrated. The method 300 begins at block 302 where a chassis defining a battery housing is provided. In an embodiment, the chassis 200, described above with reference to FIGS. 2a and 2b, is provided. In an embodiment, the providing of the chassis 200 includes positioning the battery cells 212, the tamper detection system 208, and the disabling system 210 in the housing 206 defined by the chassis 200 and then sealing the chassis 200 by, for example, securing the cover 204 to the base 202 using methods known in the art. In another embodiment, the providing of the chassis 200 includes positioning the battery cells 212 in the housing 206 defined by the chassis 200, coupling the battery cells 212 to the tamper detection system 208 and the disabling system 210 which are located elsewhere in the chassis 200, and then sealing the chassis 200 by, for example, securing the cover 204 to the base 202 using methods known in the art. In an embodiment, the photoresistor 230 of the circuit 220 is located in the housing 206 of the chassis 200 such that, if the seal of the chassis 200 (e.g., between the cover 204 and the base 202) is broken, any light entering the housing 206 will be detected by the photoresistor 230. In an embodiment, executable instructions for disabling a power supply function of the battery, the executable instructions which may be located on a computer-readable medium in the disabling system 210, are activated either during the sealing of the chassis 200 or after the chassis 200 has been sealed.

The method 300 then proceeds to block 304 where an access of the battery housing is detected. Upon sealing the chassis 200, it may be used in a variety of manners known in the art. For example, if the chassis 200 is a battery pack chassis or an IHS chassis with an integrated battery, the battery cells 212 may be charged, used, recharged, etc. However, if the housing 206 is accessed by, for example, breaking the seal of the chassis 200 (e.g., between the cover 204 and the base 202), light will enter the housing 206, as illustrated in FIG. 3b. In an embodiment, the light entering the housing may be, for example, visible light, infrared light, and/or variety of other types of light known in the art that may be detected, for example, by a photoresistor. In an embodiment, the detecting the access of the housing 206 occurs upon the light entering the housing 206 such that the photoresistor 230 is exposed to the light, and causing the photoresistor 230 to become a low impedance relative to the impedance of the photoresistor 230 when it is not exposed to light.

The method 300 then proceeds to block 306 where the power supply function is disabled. In an embodiment, the PFIN 232 of the BMU 216, which is at high under normal, untampered battery conditions, becomes low upon the photoresistor 230 becoming a low impedance (in response to, for example, being exposed to light). In an embodiment, the executable instructions for disabling a power supply function that are located in the disabling system 210 include instructions to disable the fuse 214 upon detecting PFIN 232 becoming low, and upon the photoresistor 230 being exposed to light and becoming a low impedance, the disabling system 210 detects PFIN 232 at low and disables the fuse 214 by, for example, blowing the fuse 214. Furthermore, in an embodiment, upon detecting PFIN 232 at low, the disabling system 210 sends a command to the protection circuit 218 to disable the fuse 214 using the CO pin 242. With the fuse 214 disabled, power may no longer flow from the battery cells 212 (i.e., the power supply function of the battery is disabled.) Furthermore, upon disabling the power supply function, the disabling system 210 will set a flag noting a permanent failure in the battery such that if the fuse 214 is replaced with a replacement fuse, the replacement fuse will be disabled by the disabling system 210 and/or the protection circuit 218. In an embodiment, firmware in the battery control system 213 may be instructed to mix the data in the Electrically Erasable Programmable Read-Only Memory (EEPROM) such that the settings of the battery control system 213 cannot be copied to, for example, circumvent the tamper detection system 208 and/or the disabling system 210. Thus, a system and method are provided that protect a battery from being tampered with to, for example, replace battery cells in a chassis with unqualified battery cells, by detecting tampering with the chassis and then disabling the power supply function of the battery such that it may not be used with the unqualified battery cells.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A battery tamper detection and disabling system, comprising:
a battery chassis defining a housing;
a tamper detection system located in the housing and operable to detect an access of the housing; and
a disabling system located in the housing, coupled to the tamper detection system, and operable to disable a power supply function in response to the tamper detection system detecting the access of the housing.

2. The system of claim 1, wherein the tamper detection system comprises a photoresistor.

3. The system of claim 2, wherein the disabling system comprises a battery management unit.

4. The system of claim 3, wherein the battery management unit is operable to disable a fuse, in response to the photoresistor being exposed to a light, in order to disable the power supply function.

5. The system of claim 4, wherein in response to the disabling system disabling the fuse to disable the power supply function, the disabling system is further operable to disable any replacement fuse used to replace the disabled fuse.

6. The system of claim 1, further comprising:
at least one battery cell located in the housing and coupled to the disabling system.

7. The system of claim 7, wherein the disabling system comprises executable instructions to disable the power supply function, and the executable instructions are not activated until the disabling system, the tamper detection system, and the at least one battery cell have been positioned in the housing and the battery chassis has been sealed.

8. An information handling system (IHS), comprising:
an IHS chassis defining a battery housing;
a processor located in the IHS chassis;
a storage located in the IHS chassis and coupled to the processor;
a tamper detection system located in the IHS chassis and operable to detect an access of the battery housing; and
a disabling system located in the IHS chassis, coupled to the tamper detection system, and operable to disable a power supply function in response to the tamper detection system detecting the access of the battery housing.

9. The system of claim 8, wherein the tamper detection system comprises a photoresistor.

10. The system of claim 9, wherein the disabling system comprises a battery management unit.

11. The system of claim 10, wherein the battery management unit is operable to disable a fuse, in response to the photoresistor being exposed to a light, in order to disable the power supply function.

12. The system of claim 11, wherein in response to the disabling system disabling the fuse to disable the power supply function, the disabling system is further operable to disable any replacement fuse used to replace the disabled fuse.

13. The system of claim 1, further comprising:
at least one battery cell located in the battery housing and coupled to the disabling system.

14. The system of claim 13, wherein the disabling system comprises executable instructions to disable the power supply function, and the executable instructions are not activated until the disabling system, the tamper detection system, and the at least one battery cell have been positioned in the battery housing and the IHS chassis has been sealed.

15. The system of claim 13, further comprising:
a battery chassis located in the battery housing and including the tamper detection system, the disabling system, and the at least one battery cell.

16. A method for limiting tampering with a battery, comprising:
providing a chassis defining a battery housing;
detecting an access of the battery housing; and
disabling a power supply function in response to the detected access of the battery housing.

17. The method of claim 16, wherein the providing the chassis defining the battery housing comprises:
positioning at least one battery cell, a tamper detection system, and a disabling system in the battery housing;
sealing the chassis; and
activating executable instructions on a computer-readable medium in the disabling system to disable the power supply function in response to the tamper detection system detecting the access of the battery housing.

18. The method of claim 16, wherein the detecting the access of the battery housing comprises a photoresistor detecting a light entering the battery housing.

19. The method of claim 16, wherein the disabling the power supply function comprises disabling a fuse that enables the power supply function.

20. The method of claim 19, further comprising:
in response to disabling the fuse to disable the power supply function, disabling any replacement fuse used to replace the disabled fuse.
